(19) United States
(12) Patent Application Publication
(10) Pub. No.: US 2005/0182645 A1
(43) Pub. Date: Aug. 18, 2005

(54) Interactive community website

(76) Inventors: Holger Ehlis, Manternach (LU); Kevin April, Lethbridge (CA)

Correspondence Address: BROWN, RAYSMAN, MILLSTEIN, FELDER & STEINER LLP, 900 THIRD AVENUE, NEW YORK, NY, 10022, US

(21) Appl. No.: 11/036,825

(22) Filed: Jan. 14, 2005

Related U.S. Application Data
(60) Provisional application No. 60/537,049, filed on Jan. 16, 2004.

(51) Int. Cl. G06F 17/60

(52) U.S. Cl. 705/1

(57) ABSTRACT

An interactive community websites is adapted to provide a more immersive experience for members. Various elements in the web pages displayed to a member may be dynamically modified depending upon conditions then existing at the location of the member. Members are also enabled to easily create new forums and online galleries, and to provide secret content. A member can designate their friends in the community website and, when posting content, can select whether the content should be invisible to any members that are not designated as being their friends. When a member uploads images into an online gallery, a variety of randomly generated effects can be applied to the images so that the gallery more closely resembles the appearance of a scrapbook.

This application claims the priority benefit of U.S. Provisional Patent Application No. 60/537,049 filed on Jan. 16, 2004, which provisional application is hereby incorporated dy reference in its entirety, including the appendix.

### FIELD OF THE INVENTION

The invention relates to community websites. In particular, the invention relates to improvements to the member experience on an interactive community website.

### BACKGROUND OF THE RELATED ART

An interactive community website is an online communications interchange in which peplo may communicate with each other through successive electronic transmissions between respective computer systems. An interactive community website typically has forums, chat rooms, photo galleries, blogs, personal messaging, and other types of communication services between members of the community website. The Spymac website operated by the assignee of this invention is an exemplary interactive community website that is well known in the art, especially in the Macintosh community, and often imitated or copied by others.

Interactive community websites may be implemented through a distributed network such as that shown in FIG. 1. Community members (equivalently, users of the computer services) typically are scattered across a large geographical area and communicate with a central server system 100 through respective client systems 102 (e.g., a personal or laptop computer). Although referred to in the singular, the server system 100 need not be a single monolithic entity but rather a plurality of interconnected server computers, possibly physically dispersed from each other, each dedicated to its own set of duties and/or to a particular geographical region. In such a case, the individual servers are interconnected by a network of communication links.

Each client computer system 102 runs client software, such as a web browser, that allows it to communicate in a meaningful manner with corresponding software running on the server system 100. The client systems 102 of members communicate with the server system 100 through various channels, such as a modem 104 connected to a telephone line 106, or an Internet connection using a transfer protocol such as TCP/IP (Transfer Control Protocol/Internet Protocol). The server system 100 is responsible for receiving input from the client systems 102, manipulating the collective body of input information (and possibly information from other sources) into a useful format, and retransmitting the formatted information back to one or more clients 102 for output on an output device, such as a display screen. From the perspective of the community members, there is a single shared website in which they may participate and interact with other community members.

One common type of forum is a “chat room” in which the various participants may enter text which appears in a scrolling text window on each participant'computer display screen along with the commenting user's screen name. A user may respond to the comment of another user by entering a line of text in an edit box and activating (e.g., by clicking with a pointer device, such as a mouse) a SEND button. In response, the text in the scrolling text window scrolls upwards and the newly entered line of text is displayed at the bottom of the scrolling text window.

Chat rooms and other types of forums are typically “public”, meaning that any member may participate and that all user comments may be seen by all of the website members. If a member desires some privacy, they may “open” and enter a “private” forum (for example, by clicking on a SETUP button), and thereafter invite one or more other members to enter the private forum. Once in a private forum, members may communicate with one another without fear that uninvited members will be able to see their comments, but this has the disadvantage that it is separate from the public forum and users in the private forum will be unable to see comments in the public forum without exiting the private forum and reentering the public forum. It also can be laborious to setup a separate private forum and to make a selection of other members entitled to participate in the private forum.

Photo galleries are another common service on community websites in which members post pictures for others members to view. Most online galleries are crude and wanting in their organization and presentation. It would be preferable if a member could easily setup different galleries having different collections of images. It would also be preferable if the online gallery could more closely resemble or emulate a physical scrapbook rather than a dry listing of photographs. Similarly, most interactive community websites have an overly rigid look and feel and it is preferable to provide a more immersive environment for the members that reflects the state of variable conditions existing when the member participates.

### BRIEF SUMMARY

The preferred embodiments of the invention provide improvements to the member experience on interactive community websites. Members are able to easily create new forums and online galleries. A member can designate their friends in the community website and, when posting content, can select whether the content should be invisible to any members that are not designated as being their friends. When a member uploads images into an online gallery, a variety of randomly generated effects can be applied to the images so that the gallery more closely resembles the appearance of a scrapbook.

### BRIEF DESCRIPTION OF THE DRAWINGS

The details of one or more preferred embodiments of the invention are set forth in the accompanying drawings and the description below.

FIG. 1 illustrates the architecture of a distributed computer system capable of supporting an interactive community website.

FIG. 2 illustrates the structure of the components of an exemplary server system with which the following preferred embodiments of an interactive community website may be implemented.

FIG. 3 illustrates an exemplary implementation for providing invisible content in preferred embodiments of the invention.

FIG. 4 illustrates an exemplary implementation for dynamically adjusting an interactive community website according to the current status of conditions at the location of a connected member.

FIG. 5 illustrates an exemplary implementation of a method for processing images uploaded to an interactive community website so as to achieve a digital scrapbook effect.

### DETAILED DESCRIPTION OF THE PREFERRED EMBODIMENTS

A variety of technologies are well known in the art for providing a server system capable of supporting an interactive community website. The web server may include, for example, a server computer including associated hardware and operating system software (i.e. Linux), mass storage connected to the server computer and used by the server computer in association with one or more databases, and software (i.e., Apache) for operating the server computer as a web server. In some circumstances, the functions of the operating system software and the web server software can be provided by the same software (which may be referred to as a “web operating system”). Of course, there may be any number of devices and components associated with the server system, which are well known and available to those of ordinary skill in the art for any particular implementation.

The functionality and features of any particular website provided by a web server is largely determined by the software, scripts and other programming provided specifically for that website by installation onto the web server. The features and improvement described in the following preferred embodiments can thus be provided to any existing or future website merely by providing and installing appropriate software program(s) on the server computer. Installation can be accomplished by recording the software program(s) on a tangible medium, such as a CR-ROM readable by the computer, and transferring the software program(s) into memory or storage so as to provide the functions and features when executed by the server computer.

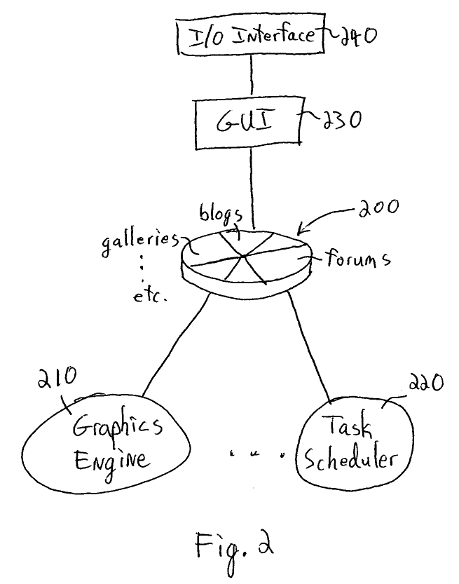

FIG. 2 shows an example of the structure of the software on the web server computer in the following preferred embodiments of the invention to provide an interactive community website. A core 200 of various software applications installed on the server computer provides various respective functions and features. There may be, for example, respective software applications for providing forums, online galleries, web logs, etc. Preferably, many if not all of the various applications in software core 200 are provided as modules that may be operated independently of the other applications in software core 200.

A number of back-end software tools are provided and made available in the server computer to be utilized by the software applications in core 200. These tools may include a graphics engine (GE) 210 and a task scheduler (TS) 220. These tools operate in conjunction with other parts of the server computer as well known to those of ordinary skill in the art. For example, graphics engine 210 may operate by retrieving and storing images and graphics in conjunction with storage and databases (not shown). On the front end, web pages are formed by using graphical user interface (GUI) 230 through, for example, point and click selection of various web elements included in a displayed web page. The web elements may include any variety and configuration of buttons, drop down menus, etc. The web pages are preferably formed using Hyper-Text Markup Language (HTML) and other standardized technologies, making them compatible with a large variety. of web browsers. An input/output (I/O) interface 240 provides and controls the connections of web pages formed by GUI 230 between the server computer and the client computers. I/O interface 240 need not be software and may be implemented in part by hardware considerations as well as software.

As mentioned above, conventional community websites utilize public content visible to every community member or private forums in which only certain designated members may participate. In one preferred embodiment, a member posting content has the option to designate some of the content it posts as being “invisible” so that such content cannot be viewed by all of the community members and can only be viewed by certain other community members permitted to do so. The content may be, for example, a comment on a public forum or certain picture in one the member's online galleries. In particular, the invisible content may be made on a public forum or gallery so that no special provisions need to be made for a private forum. This characteristic allows community members to communicate secretly even on public forums. The posting member may designate or otherwise decide who can view their invisible content via an easy-to-user interface. The Invisible Ink is embedded into discussion board threads and other parts of the site and requires that:

As an additional feature, the community members who are allowed to view another user's Invisible Ink must approve and accept the request, providing an extra level of privacy and security. Members can allow as many users as they choose to view their Invisible Ink, and Invisible Ink messages are completely hidden from other site users who do not have the proper authorization.

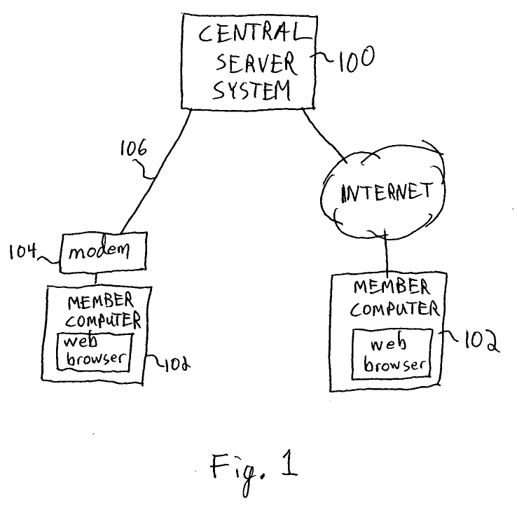

The manner of designating posted content as invisible and using Invisible Ink is quick and easy. When a community member replies to a topic, the “Use Invisible Ink” checkbox appears. The member simply selects this box before submitting their post, and the content becomes invisible. (See FIG. 1 of the provisional application)

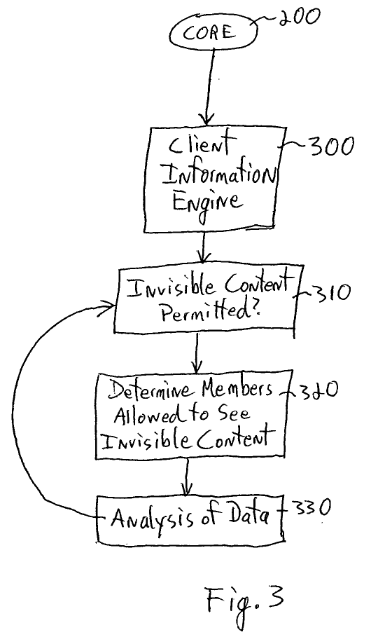

FIG. 3 illustrates an example of how the invisible content feature may be implemented in a server system. When a software application, such as a software for providing and managing forums, in core 200 is utilized by a member, the information concerning that member in a client information engine (CIE) 300 is accessed. The member information in CIE 300 includes the various data that constitutes the user profile of the member, and additionally contains information relating to the invisible content feature and the friends or other persons in the member's alliance system. For example, the invisible content feature may only be made available to certain members, perhaps for a fee, and this information is managed in CIE 300.

Based on the information in CIE 300, when the member interacts with the forum software or other software application, it is determined at step 310 whether or not the member is authorized to post invisible content in the software application. If authorized, the member has the opportunity to interact with the application in such a manner as to designate content they post as invisible. Furthermore, at step 320, the CIE 300 is consulted to determine which other members are allowed to see the invisible content posted by the member. At step 330, content and other data is analyzed to determine which data is to be posted as invisible content. The analysis of the data may consist of a simple check to determine whether or not an invisible content bit flag associated with the content is set to invisible or not. If any of the authorized members are online, the information displayed to them is updated to include the invisible content posted by the posting member.

As explained, posted invisible content (forum message, etc.) will thereafter be visible only to the member and to their friends who have authorization. A friend manager screen or other type of community alliance system is preferably provided so that members can easily manage and control which member are their friends and can view their invisible content (See FIG. 2 of the provisional application). Each member has control over who views what content, and may choose to ignore the content of other members. To let another member view their Invisible Ink, they must be added as a friend. Preferably, that person, in turn, must accept the friendship request. Invisible content may set to appear differently than other content. For example, invisible ink messages may appear in red text to those allowed to see them.

Members can control which members can view their invisible content and secret images. Each user has control over who views what content, and may choose to ignore the content of other members. Additionally, members are able to use the friend manager or other alliance system to be notified in real-time when their friends sign into the community website and may track the activity of other members.

When a member receives a new message from, or sends a message to, a designated friend or other member of an alliance system, the commnunity website may display a message notification in real-time or substantially near real-time, such as a simple graphic, displaying the amount of new messages that user has and reflecting the change. (see FIG. 12 of the provisional application) This notification preferably has a look and feel similar to the message notification operation of a desktop operating system. The graphical notification can appear anywhere on the site and can be integrated with navigational elements, such as the icon for web-mail. After the member reads a message, the notification changes automatically to correspond with the amount of remaining new messages in the members inbox. (See FIG. 13 of the provisional application)

In another aspect of the preferred embodiments, members of the interactive community website are able to create complete new forums and other communication services with ease and a minimal of input and setup. The facilitation of member generated forums and galleries allows the population of community site to grow exponentially while increasing the content level and usefulness of the site. The technology allows each community member to start his/her own forum or gallery. The individual forum and gallery is able to build up its own list of members and can be created on any topic of interest to the creator.

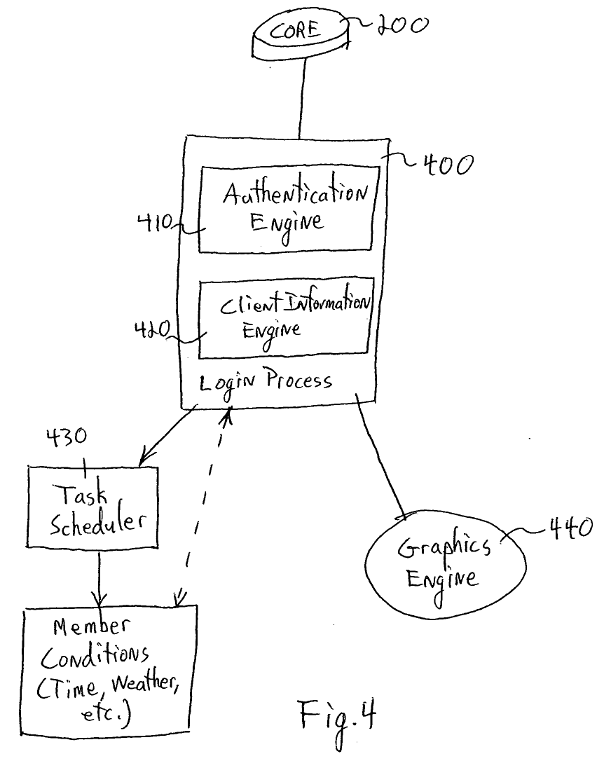

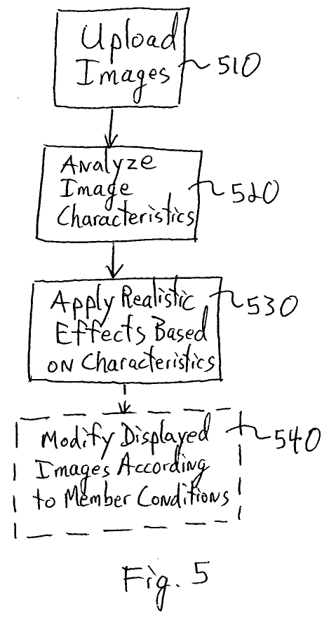

Preferably, such forums and galleries can be created by members in only two simple steps. The first step constitutes clicking on a button or other user selectable web element. The element may be labeled “Create Discussion Board” or similar (See FIG. 4 of the provisional application). Secondly, the member input only basic information for the new forum, such as name, etc. The new discussion board is then created automatically and is ready to accept new members and accept new posts and polls without further action being necessary on the part of the member creating the forum. (See FIG. 5 of the provisional application)

Preferably, the generation process relies on the member-data of the parent site to allow for quick member registration. When a member wants to participate in a member created forum, he/she simply browses a list of all of the forums on the community website, and subscribes to the ones he/she is interested in with a single click of the mouse. (See FIG. 6 of the provisional application). Alternatively, the website can provide search and/or browsing capability so that the list of forums can be reduced in some way to be a subset of all of the forums on the community website. For example, a list may be composed of only the member created forums or forums relating to a particular subject area. The member created forums rely on the member-data of the parent site but keep independent post counts, members and individual board characteristics. It is a highly advantageous feature of the member created forums that subscribed members can start new discussions directly into them, harnessing the high traffic and community website.

Another aspect of the interactive community website according to the preferred embodiments is that it can be dynamically synchronized with circumstances at a member's location and changes its look and feel to correspond with those circumstances. Keeping in mind that the membership of an interactive online community website may be geographically dispersed, the system may dynamically adjust to the clock of the member's computer, for example, and progressively change its look and feel to correspond with the time of the member. For example, navigational elements darken and change as night arrives; system-messages adapt to the time of the member and the general behavior of the site is different depending on the time of day it is visited. Other conditions uniquely related to the member can also be taken into account, such as weather, computer status, etc.

Preferably, the community website automatically determines the conditions relating to the member as soon as he/she visits the community website, making activation of the feature transparent to the member. FIG. 4 illustrates an exemplary process for dynamic adjustment. When a user accesses the community website and launches any of the software applications in core 200, they will undergo a login process 400. The login process includes an authentication engine 410 which authenticates the user as a member of the community website and approves their entry into the community website. A client information engine 420 (which may be the same as CIE 300 in FIG. 3) is accessed and contains a profile and other information about the member. The information in CIE 420 may include, for example, information indicating whether or not the dynamic immersion feature is authorized for the member and/or selected by the member.

After login, the login process 400 sends a request to task scheduler 430 (which is preferably the same as task scheduler 220) for it to obtain information about the conditions at the location of the member. Task scheduler 430 may then communicate with the client computer of the member and obtains information therefrom, such as the time of the system clock of the client computer, and other information from the client computer. Alternatively, the task scheduler may obtain information about conditions, such as weather, at the location of the member from a third party, using for example, the zip code provided by the member when joining the community website.

When the information is obtained, it is stored temporarily, preferably in CIE 420, and utilized to provide a dynamic adjustment of the community website as it is displayed. This information may be provided, for example, to graphics engine 440 and is used to provide appropriate graphics and adjustments to images and other display elements in the community website. This results in an immersive experience that provides the member with the feeling that the site shares the same characteristics as his/her current conditions. (See FIG. 11 of the provisional application)

The images may also change based on the time of the member computer's system clock. Each minute/hour of the day can correspond with different images. The community website creates images for the various time possibilities and tells the system which images correspond with which times of the day. When the community web site is loaded, the dynamic feature outputs the results into the normal HTML format so that modification by the member is necessary.

The easy creation of forums by members in only two steps is facilitated by steps taken in the forum management software application in software core 200. As well known to those of ordinary skill in the art, forum management software application handles a large number of functions and operational considerations associated with online forums. These include, for example, administrator privileges, editing controls, member posting rules, settings of various types, etc. Many of the functions are merely duplicated in member created forums and are the same as in forums created and sponsored by the community website. Thus, the simplified creation of member forums is made possible by tagging or otherwise identifying the portions of the forum management software application in core 200 that should be utilized in the creation of member forums are tagged or otherwise identified during the programming of the forum management software application. When members select a “Create Forum” button or similar, a software programmed method is initiated in which instances of the tagged or otherwise identified portions in the programming of the forum are recreated and used to generate the member created forum. While many of the settings are adjusted for forums sponsored by the website, most members seeking to create their own forum do not wish to have to address such details. Thus, the creation of forums by members is facilitated by utilizing the default settings. Thus, the member can easily create a forum by providing only basic information such as the title and subject matter of the forum.

In addition to forums, the community website also preferably permits galleries and other services to be easily created by members in a simple two click process described above for forums. This feature allows the community members to grow exponentially while increasing the content level and usefulness of the site and allows each community member to start his/her own gallery. The individual gallery is able to build up its own list of members and can be created on any topic of interest to the creator.

Preferably, members are able to create their own digital photo gallery in only two simple steps. First, the member clicks on a button or other selectable web element. The web element may be labeled “Create Gallery” for example (See FIG. 7 of the provisional application). Secondly, the member inputs basic information, such as a name, etc., for the new gallery. The new gallery is then created automatically and is ready to accept new members and accept new pictures. (See FIG. 8 of the provisional application)

The member created galleries preferably rely on the member-data of the parent site to allow for quick member registration. When a member wants to participate in a gallery created by another member, he/she simply browses a list of all galleries, and subscribes to the ones he/she is interested in with a single click of the mouse. (See FIG. 9 of the provisional application). The member created galleries rely on the member-data of the parent site but keep independent post counts, members and individual gallery characteristics. An advantageous aspect of the member created galleries is that subscribed members can upload pictures directly into, harnessing the high traffic and community of the parent site.

Preferably, the community website is capable of organizing and processing member created galleries and other images uploaded to the site to have receive the realistic look and feel of actual photograph, such as might be experienced in a physical scrapbook. Using a combination of random behavior, masking, framing and custom-algorithms, digital image thumbnails are created with characteristics of images placed in a scrap book. Any number of effects may be applied. These may include, for example, ripped corners; slanted or slightly rotated images, etc. Depending on the characteristics of the image upload (file size, height, width, time of upload, location of upload), the pictures may receive additional attributes such as a digital stamp. The image may contain other visual artifacts such as fading or discoloration designed to emulate the look of a real worn photograph. Each image in the gallery or scrapbook thus looks visually unique from other images because of the algorithms and random-behavior routines used.

The features can be implemented in any number of ways. As an example, the method shown in FIG. 5 may be applied. At step 510, a plurality of images are uploaded by the member, for example, into an online gallery that the member has created. The images are received and analyzed by the graphics engine (step 520) in the server according to an algorithm including random elements to determine the effects to be applied to each one of the images. Preferably, there are a plurality of different predefined types of effects and certain characteristics of each type of effect that may be varied to some extent. These effects may include for example effects simulating the application of pins, tapes, etc., to attach the image to a scrapbook. The pins and tapes may be of different sizes and shapes and may be applied at different randomized angles and locations on the images. At step 530, the effects are applied by the graphics engine as an overlay on the original images in a manner well known in the art using scripts stored and executed in the server. The method may include an optional step 540, in which the image is further processed in consideration of the conditions of the member, such as time, weather, etc., described above.

One of the plurality of different predetermined effects is selected for use with each individual image using an algorithm and process described below, but is not necessarily immediately applied to the image when the images are uploaded. Scripts are stored in the server system and may be executed to apply the selected effects to the images whenever called upon by the server. The original images can be stored and then outputted to various services, such as public galleries, system elements, private galleries and other aspects of the community website upon demand. It may also be arranged that, even though the full size image is not modified with the effects, thumbnail images can be derived from the full size images and immediately processed to have the realistic effects.

Each one of the images is analyzed to select an effect by first determining certain format related characteristics of the image. These image characteristics include the width, height, color and size of the images. From these characteristics, it may be estimated that the image is a portrait, landscape, square or unknown type of format. All of the different effects are available for each format type, but each one of the predetermined effects has a respective weighting factor for each format type. The effect is selected at random but is a function of the respective weighting factor.

A framework is configured for each image by creating four borders for the image and creating four corners around the image. The image may be resized and is then rotated by a small (plus or minus ten degrees) random amount. After these manipulations, the selected effect (tapes, pins, etc.) is overlayed onto the composite image. A typical image gallery resulting from the method is shown in FIG. 10 of the provisional application.

Although the various improvements in the preferred embodiments described above may together collectively improve the experience of the community website members and may interact in the ways described (indeed they are already all included in the Release 3 (2004) of the Spymac community website), it should be kept in mind that any of the improvements may also be of benefit if implemented independently in other embodiments of the invention.

1. An interactive community website, adapted to provide interactivity with a plurality of members, the website comprising the features of:
permitting members to provide secret content that appears only to members allowed to see the secret content;
permitting members to control which ones of the plurality of members can view their secret content;
permitting members to create their own forum or photo gallery by only clicking on an interactive element and inputting a name for the forum or photo gallery;
automatically modifying pictures uploaded by a member to have effects that cause the picture to resemble an actual photograph; and
changing a plurality of the elements of the website displayed to a member depending upon conditions existing at the location of the member.

2. The interactive community website recited in claim 1, wherein the conditions existing at the location of the member include the current time at the location of the member.

3. The interactive community website recited in claim 2, wherein the current time at the location of the member is obtained from the computer system of the member.

4. The interactive computer website recited in claim 1, where the conditions existing at the location of the member includes the current weather.

5. The interactive computer website recited in claim 1, wherein a client information engine in a server providing the website includes information indicating which members are authorized to post secret content.

6. The interactive computer website recited in claim 5, wherein the client information engine includes information indicating which ones of the plurality of members are authorized to view the secret content of another member.

7. A method of enabling one member of an interactive community website to create a forum available to other members of the interactive community website, said method consisting of the steps of:
providing a web element on a web page displayed to said one member; and
when said web element is selected by said one member, displaying a field for said one member to input the title and the subject matter for the forum.

8. The method recited in claim 7, wherein said one member may designate the other members of the interactive community website authorized to participate in the user forum.

9. The method recited in claim 7, wherein the user forum is created by retrieving pre-designated portions of a forum management software application for website forums.

10. A method of processing a plurality of images in an interactive community website to simulate a scrapbook, said method comprising the steps of:
receiving the plurality of images in an upload from a member of the interactive community website;
determining characteristics of each one of the plurality of images;
selecting one of a plurality of different predetermined types of effect for each image based on the determined characteristics of the image;
determining borders and corners for each image;
rotating each image by a small random amount; and
processing each one of the images to apply the selected predetermined type of effect and the determined borders and corners.

11. The method according to claim 10, wherein the predetermined types of effects include the simulated application of tapes and pins, and the characteristics of the images used to select the predetermined type of effect for an image include the wdith, height, color and size of the image.
